(19) United States
(12) Patent Application Publication
(10) Pub. No.: US 2010/0264122 A1
(43) Pub. Date: Oct. 21, 2010

(54) LASER SCRIBER WITH SELF-CORRECTING MECHANISM AND SELF-CORRECTION METHOD THEREOF

(75) Inventors: Shih-Wei Lee, Kaohsiung County (TW); Chi-Hung Hou, Taipei City (TW); Tsung-Yuan Wu, Kaohsiung County (TW)

Correspondence Address: WPAT, PC;INTELLECTUAL PROPERTY ATTORNEYS, 2030 MAIN STREET, SUITE 1300, IRVINE, CA, 92614, US

(73) Assignee: AXUNTEK SOLAR ENERGY CO., LTD., Kaohsiung County (TW)

(21) Appl. No.: 12/577,318

(22) Filed: Oct. 12, 2009

(30) Foreign Application Priority Data
Apr. 16, 2009 (TW) 098112714

(51) Int. Cl. B23K 26/00

(52) U.S. Cl. 219/121.69; 219/121.68

(57) ABSTRACT

A laser scriber with a self-correcting mechanism comprises a laser scribing unit, a detection unit, a control unit and a drive unit. The laser scribing unit scribes a pattern on a solar panel according to a drive signal. The detection unit detects the pattern to generate a correction signal. The control unit corrects a scribing program based on the correction signal. The drive unit generates the above-described drive signal based on the scribing program. A self-correction method of a laser scribing process comprises the steps of: setting a scribing program on a laser scriber; fixing a solar panel to the laser scriber and performing a position calibration procedure; scribing a pattern on the solar panel via the laser scriber based on the scribing program; examining whether the pattern corresponds to a specification or not; and if no, automatically generating a patch program to replace the scribing program.

### BACKGROUND OF THE INVENTION

(a) Field of the Invention

The present invention relates to a laser scriber, and more particularly to a laser scriber with a self-correcting mechanism.

(b) Description of the Prior Art

Presently, both the principle and production equipment for solar panels belong to the field of semiconductors, but only the production technology and equipment for wafers or liquid crystal panels are transferred to the solar panel production, resulting in many deficiencies. Due to the multi-layer structure of a wafer, the requirement on the precise alignment of each of the layers is very strict. Nevertheless, a solar panel only has a two- to three-layer structure, and therefore, accuracy often accommodates itself to mass production. A high-precision and costly laser scriber is used to scrape the coating layer on a portion of a wafer or liquid crystal panel during the production of wafers and liquid crystal panels. Besides, in order to increase the production capacity, a large amount of wafers are scribed and cut in a laser scriber and then sampled and inspected at an inspection machine, such as a charge-coupled device (CCD), in current semiconductor fabs. However, this flow process is not the optimum flow process for the production of solar panels. Compared with the precise alignment of each of the layers that is emphasized in wafers and liquid crystal panels, accurate scraping off of a portion of a single layer is more emphasized in solar panels because a good line width control helps to control the electrical resistance value of a solar panel. Accordingly, the procedure that a large amount of wafers are subjected to a laser scribing process followed by the sampling inspection of products via a CCD camera in a conventional flow process for the production of semiconductors is not suitable for the production line of solar panels.

To solve the various problems of the prior art, the inventors propose a laser scriber with a self-correcting mechanism and a self-correction method thereof based on their research and development for many years and plenty of practical experience, thereby overcoming the above-described drawbacks.

### SUMMARY OF THE INVENTION

In view of the above-described circumstances, it is an object of the present invention to provide a laser scriber with a self-correcting mechanism and a self-correction method thereof so as to solve the deficiency that the requirements for the solar panel manufacturing process cannot be met by using conventional semiconductor equipments.

According to the object of the present invention, there is provided a laser scriber with a self-correcting mechanism, which comprises a laser scribing unit, a detection unit, a control unit and a drive unit. The laser scribing unit scribes a pattern on a solar panel according to a drive signal. The detection unit detects the above-described pattern to generate a correction signal. The control unit corrects a scribing program based on the correction signal. The drive unit generates the above-described drive signal based on the scribing program.

Furthermore, the present invention provides a self-correction method of a laser scribing process. The method comprises the following steps: firstly, setting a scribing program on a laser scriber for generating a pattern on a solar panel; next, fixing the solar panel to the laser scriber and performing a position calibration procedure; then scribing the above-described pattern on the solar panel via the laser scriber based on the scribing program; subsequently, examining whether the pattern corresponds to a specification or not; if yes, removing the solar panel from the laser scriber to release the solar panel; and if no, automatically generating a patch program to replace the scribing program.

As described above, the laser scriber with a self-correcting mechanism and the self-correction method thereof according to the present invention have the following advantages:

(1) The detection unit can be used to correct the scribing program at any time by means of the laser scriber with a self-correcting mechanism and the self-correction method thereof according to the present invention.

(2) The time required to transfer solar panels from a conventional laser scriber to a detection machine can be saved by means of the laser scriber with a self-correcting mechanism and the self-correction method thereof according to the present invention.

(3) By means of the laser scriber with a self-correcting mechanism and the self-correction method thereof according to the present invention, it requires the position calibration procedure to be performed on a solar panel once only, and thereby so higher accuracy can be achieved when the pattern is corrected via the laser scriber.

(4) The higher accuracy can be provided during pattern correction according to the laser scriber with a self-correcting mechanism and the self-correction method thereof the the present invention, so as to avoid the unnecessary expense of the effective areas can be avoided.

The technical features and effects of the present invention may be further understood and appreciated from the following detailed description of the preferred embodiments.

### BRIEF DESCRIPTION OF THE DRAWINGS

FIG. 1 is a schematic view showing a structure of a laser scriber with a self-correcting mechanism according to the present invention;

FIG. 2 is a schematic view showing a structure of a laser scriber with a self-correcting mechanism according to another embodiment of the present invention;

FIG. 3 is a flow chart showing the steps of a self-correction method of a laser scribing process according to the present invention; and

FIG. 4 is a flow chart showing the steps of a self-correction method of a laser scribing process according to another embodiment of the present invention.

### DETAILED DESCRIPTION OF THE PREFERRED EMBODIMENTS

Hereinafter, description of the laser scriber with a self-correcting mechanism and the self-correction method thereof according to the preferred embodiments of the present invention will be given with reference to the related drawings. For the convenience of understanding, the same parts should have the same reference numerals in the following embodiments.

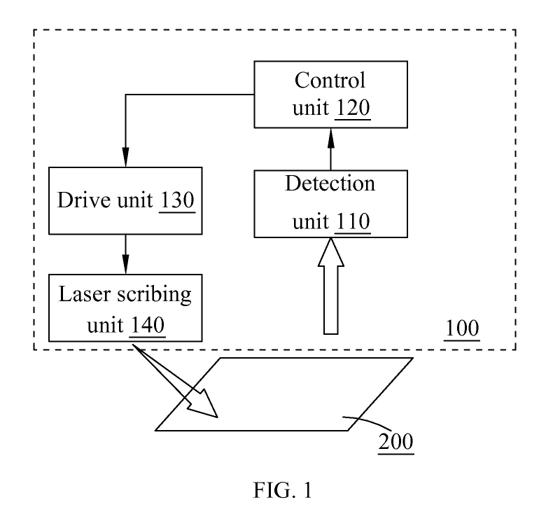

Referring to FIG. 1, a schematic view showing a structure of a laser scriber with a self-correcting mechanism according to the present invention is shown. In this figure, the laser scriber with a self-correcting mechanism 100 comprises a laser scribing unit 140, a detection unit 110, a control unit 120 and a drive unit 130. The laser scribing unit 140 is used to scribe a pattern on a solar panel 200 according to a drive signal. The detection unit 110 is used to detect the above-described pattern to generate a correction signal. The control unit 120 is used to correct a scribing program based on the correction signal. The drive unit 130 is used to generate the above-described drive signal based on the scribing program.

The detection unit 110 can be a charge-coupled device (CCD) camera. The detection unit 110 can be used to detect a line width of the pattern and thus to perform self-correction at any time. The detection unit 110 may also include a probe-type detecting apparatus for detecting an electrical resistance value of the pattern. In other words, if the electrical resistance value does not correspond to the specification during the detection of insulation resistance, the laser scriber with a self-correcting mechanism can directly and accurately perform a laser repair. For instance, a line width formed by a conventional laser scriber is about 50 μm. If a solar panel is moved out of a conventional laser scriber for detection and then returned to the laser scriber for repair, a precise alignment cannot be achieved. However, the laser repair can be repeatedly made on the same equipment via the laser scriber with a self-correcting mechanism according to the present invention as long as the position calibration procedure is performed once only.

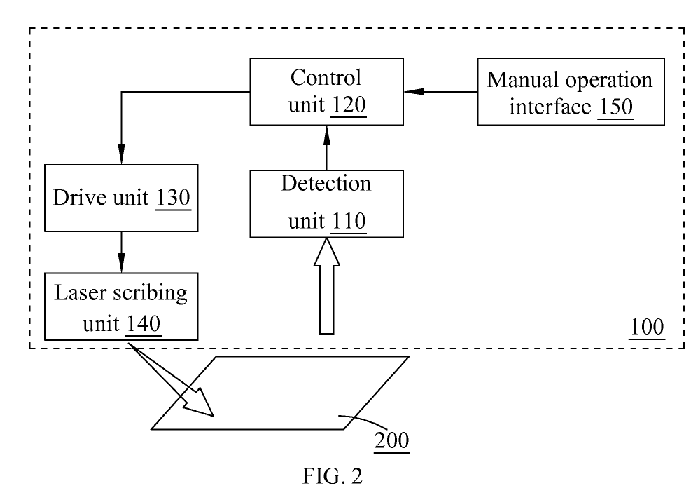

Referring to FIG. 2, a schematic view showing a structure of a laser scriber with a self-correcting mechanism according to another embodiment of the present invention is shown. In this figure, the laser scriber with a self-correcting mechanism 100 of this embodiment further comprises a manual operation interface 150 for bypassing the correction signal. In other words, when the laser scriber with a self-correcting mechanism 100 of this embodiment performs the laser repair on the same solar panel 200 repeatedly and the panel cannot meet its predetermined specification, the laser scriber with a self-correcting mechanism 100 of this embodiment can provide a manual operation interface 150 for manual operation and thus to exclude the solar panel 200.

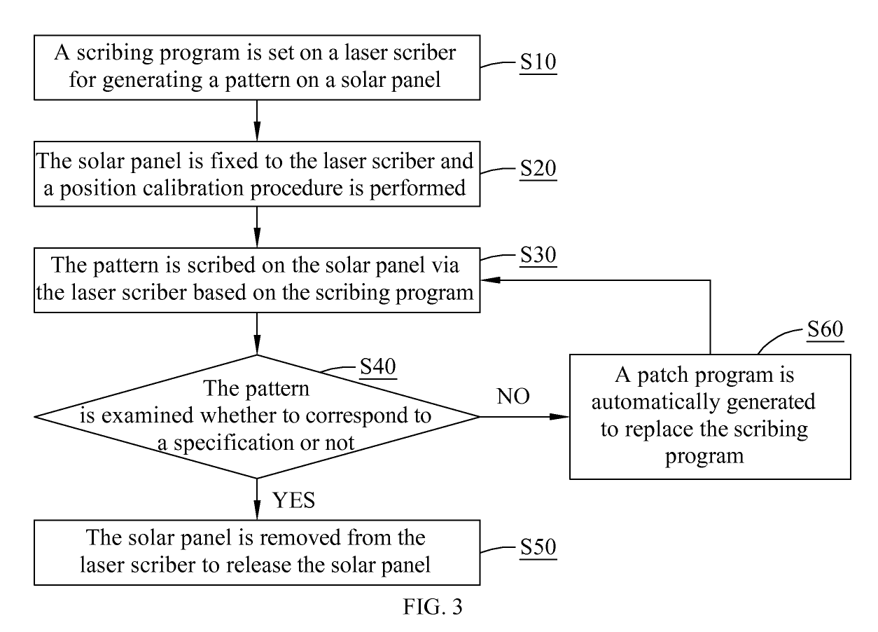

Referring to FIG. 3, a flow chart showing the steps of a self-correction method of a laser scribing process according to the present invention is shown. In this figure, the self-correction method of a laser scribing process according to the present invention comprises the following steps. Firstly, as shown in step S10, a scribing program is set on a laser scriber for generating a pattern on a solar panel. Next, as shown in step S20, the solar panel is fixed to the laser scriber and a position calibration procedure is performed. Then, as shown in step S30, the above-described pattern is scribed on the solar panel via the laser scriber based on the scribing program. Subsequently, as shown in step S40, the pattern is examined whether to correspond to a specification or not. If yes, as shown in step S50, the solar panel is removed from the laser scriber to release the solar panel; if no, as shown in step S60, a patch program is automatically generated to replace the scribing program.

The above-described specification can be a line width or an electrical resistance value of the pattern. In other words, if the electrical resistance value does not correspond to the specification during the detection of insulation resistance, a laser repair can be directly and accurately performed by the self-correction method of a laser scribing process according to the present invention. Hereby, the self-correction method of a laser scribing process according to the present invention can allow reducing the time required for the manufacturing process.

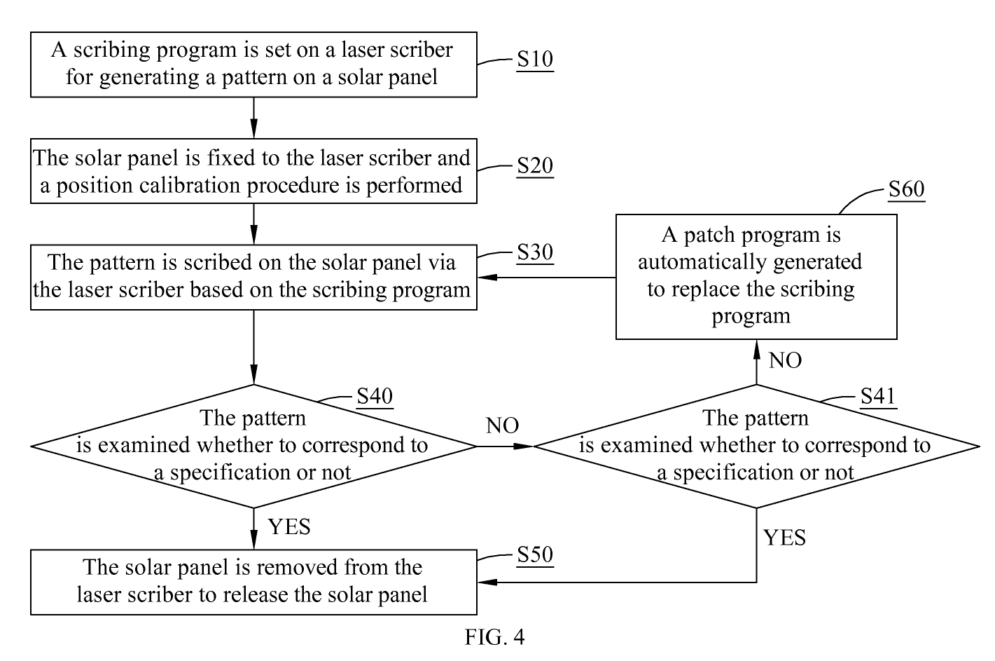

Referring to FIG. 4, a flow chart showing the steps of a self-correction method of a laser scribing process according to another embodiment of the present invention is shown. In this figure, as shown in step S41, the self-correction method of a laser scribing process according to the present invention further comprises a manual operation interface for releasing the solar panel. Moreover, in this embodiment, the position calibration procedure described in step S20 may be an optical alignment calibration procedure, that is, the alignment is performed using an optical mark. Or, the position calibration procedure may also be a structure alignment calibration procedure, that is, a notch is formed on a solar panel as an alignment reference in advance and the alignment is performed by the engagement of the equipment with the notch. As described above, the laser repair can be repeatedly performed on a solar panel by the self-correction method of a laser scribing process according to the present invention as long as the position calibration procedure is performed once only, thereby significantly improving the laser repair accuracy. When considering from another viewpoint, the self-correction method of a laser scribing process according to the present invention can provide good accuracy to avoid the unnecessary expense of the effective areas in laser repairing.

The above description is illustrative only and is not to be considered limiting. Various modifications or changes can be made without departing from the spirit and scope of the invention. All such equivalent modifications and changes shall be included within the scope of the appended claims.

What is claimed is:

1. A laser scriber with a self-correcting mechanism comprising:
a laser scribing unit, scribing a pattern on a solar panel according to a drive signal;
a detection unit, detecting the pattern to generate a correction signal;
a control unit, correcting a scribing program based on the correction signal; and
a drive unit, generating the drive signal based on the scribing program.

2. The laser scriber with the self-correcting mechanism as claimed in claim 1, wherein the detection unit is a charge-coupled device (CCD) camera for detecting a line width of the pattern.

3. The laser scriber with the self-correcting mechanism as claimed in claim 1, wherein the detection unit is a probe-type detecting apparatus for detecting an electrical resistance value of the pattern.

4. The laser scriber with the self-correcting mechanism as claimed in claim 1, further comprising a manual operation interface for bypassing the correction signal.

5. A self-correction method of a laser scribing process comprising the following steps:
setting a scribing program on a laser scriber for generating a pattern on a solar panel;
fixing the solar panel to the laser scriber and performing a position calibration procedure;
scribing the pattern on the solar panel via the laser scriber based on the scribing program;
examining whether the pattern corresponds to a specification or not;
if yes, removing the solar panel from the laser scriber to release the solar panel; and
if no, automatically generating a patch program to replace the scribing program.

6. The self-correction method of a laser scribing process as claimed in claim 5, wherein the specification is a line width of the pattern.

7. The self-correction method of the laser scribing process as claimed in claim 5, wherein the specification is an electrical resistance value of the pattern.

8. The self-correction method of the laser scribing process as claimed in claim 5, further comprising a manual operation interface for releasing the solar panel.

9. The self-correction method of the laser scribing process as claimed in claim 5, wherein the position calibration procedure is an optical alignment calibration procedure.

10. The self-correction method of the laser scribing process as claimed in claim 5, wherein the position calibration procedure is a structure alignment calibration procedure.
